(19) United States
(12) Patent Application Publication
(10) Pub. No.: US 2021/0149275 A1
(43) Pub. Date: May 20, 2021

(54) DEVICE FOR CAPTURING MULTIPLE IMAGES EACH HAVING A DIFFERENT LIGHT EXPOSURE

(71) Applicant: GEODE, LYON (FR)

(72) Inventors: David ALLOZA, Grenoble (FR); Pascal STRADELLA, LYON (FR); Carole LIEFKE, LYON (FR)

(21) Appl. No.: 17/045,374

(22) PCT Filed: Apr. 8, 2019
(86) PCT No.: PCT/EP2019/058793

§ 371 Date: Oct. 5, 2020

(30) Foreign Application Priority Data
Apr. 6, 2018 (FR) 1853036

(51) Int. Cl. G03B 15/05

(52) U.S. Cl. CPC G03B 15/05

(57) ABSTRACT

A device and method for capturing multiple images including a set of light emitting units disposed on a flat surface as well as at least one image capturing unit in order to create as many different exposures as light emitting units.

### CROSS REFERENCE TO RELATED APPLICATIONS

This application is a National Stage of PCT Application No. PCT/EP2019/058793 filed on Apr. 8, 2019, which claims priority to French Patent Application No. 18/53036 filed on Apr. 6, 2018, the contents each of which are incorporated herein by reference thereto.

### FIELD OF THE INVENTION

The present invention relates to a device for capturing multiple images.

### PRIOR ART

In a known manner, a device making it possible to capture several images of the same object with several different light exposures is used under the trade name TAC7 Scanner. The described device is in the shape of a dome inside which several LED type light emitters as well as several monochromatic cameras are placed.

In a known manner, a device making it possible to capture several images of the same object with several different light exposures is the subject of the patent U.S. Pat. No. 6,654,013 in which a graphic system is described which makes it possible to highlight the perception of shapes. The graphic system relates to a technique of creating interactive display images of objects exposed to different light conditions in order to reveal surface phenomena.

The device used for the creation of the interactive display is a dome including several light emitters as well as an orifice at its top in order to place an image capturing unit therein.

However, these solutions are not entirely satisfactory.

The construction of a dome is tricky to achieve and its shape makes the automation of the process difficult, which makes the cost of production high. In addition, a dome is bulky, which involves several drawbacks, particularly during transport.

The object of the present invention is to resolve all or part of the drawbacks mentioned above.

### DISCLOSURE OF THE INVENTION

To this end, the present invention concerns a device for capturing multiple images of an object disposed at a reference position, each image having a different exposure to light, the device comprising:

a set of light emitting units comprising at least one light emitting unit disposed on a flat surface;

at least one image capturing unit;

a monitoring unit; and

the monitoring unit being arranged to control all of the light emitting units disposed on a flat surface so as to provide lighting for each light emitting unit with at least one light characteristic determined as a function of the distance between a lighting position of the light emitting unit and the reference position.

In a system where the different positions of the light source are distributed over a hemisphere, the distance from the source to the target is constant.

In the system described here, the simplified construction which consists in positioning the light source on different points of a plane causes a variation in the distance from the source to the target.

The consequence of this variation in distance is an unwanted variation in the light intensity received by the target.

The described system integrates an algorithm compensating in an acceptable approximation this unwanted lighting variation by modulating the light intensity of the source in reverse of the variation caused by this non-constant distance.

Thus, the light sources placed close to a location will generate much less lighting than those placed at the periphery of the system.

Thanks to these arrangements, the invention provides a solution whose automation is simplified, whose production cost is low and whose size is minimal.

According to an aspect of the invention, the considered light characteristic corresponds to a light intensity of the emitting unit.

According to a possibility, the light intensity of the light emitted by the light emitting units can thus be calculated as a function of a ratio between the distance between a lighting position of an emitting unit and the reference position.

Particularly, the controlled light intensity for a light emitting unit can be modulated according to a ratio:

$$\frac{d}{{d}_{max}}$$

The value d corresponds to the distance between the lighting position of the emitting unit and the reference position. The value dₘₐₓ corresponds to the distance between the lighting position of an emitting unit furthest from the reference position among the plurality of lighting position of the assembly of the emitting unit and the reference position.

Thus, the light intensity I can be determined as a function f of the ratio described above and of a maximum light intensity Iₘₐₓ available or determined for an emitting unit:

$$l = f ( \frac{d}{{d}_{max}} , {I}_{max} )$$

According to a possibility, the light intensity controlled for a light emitting unit can be modulated according to the square of the ratio previously described, that is to say according to a magnitude:

$${( \frac{d}{{d}_{max}} )}^{2}$$

Thus, the light intensity I can be determined as a function f of the square of the ratio described above and of a maximum light intensity Iₘₐₓ available or determined for an emitting unit:

$$l = f ( {( \frac{d}{{d}_{max}} )}^{2} , {I}_{max} )$$

According to a particular non-limiting example of expression of the function f, the light intensity can be determined as follows:

$$l = {( \frac{d}{{d}_{max}} )}^{2} {I}_{max}$$

Of course, an approximate calculation of the function f can be used so as to facilitate the implementation of the determination.

The control unit is thus configured to control the lighting light intensity for each of the emitting units by modulating the intensity using the above function.

According to an aspect of the invention, the light emitting units can be of any kind such as light-emitting diodes and/or xenon lamps for example.

According to an aspect of the invention, the flat surface on which the light-emitting units are placed has at least one location so as to allow the insertion of at least one image capturing unit.

According to an aspect of the invention, the at least one image capturing unit can be of any kind, such as a digital camera or a film camera for example.

According to an embodiment, the at least one image capturing unit is controlled by the monitoring unit.

The invention also concerns a method for capturing multiple images each having a different light exposure, including the following steps:

positioning an object to be photographed at a reference position;

triggering a plurality of image capture from a shooting position;

in which, during an image capture, lighting is provided from a lighting position, the plurality of images capture being associated with a plurality of lighting position comprised in a lighting plane; and

in which, the lighting is produced from the plurality of lighting position with at least one light characteristic determined as a function of the distance between the lighting position and the reference position.

According to an embodiment, the triggering of the different light emitting units is carried out according to different light characteristics depending on the distance which separates them from the reference position.

The definition of the function f detailed previously can be used.

According to an aspect of the invention, the triggering of the light emitting units according to different light characteristics as a function of the distance which separates them from the reference position makes it possible to simulate natural lighting.

According to an embodiment, the intensity of the light emitted by the light emitting units depends on the distance separating them from the reference position in order to obtain, for each of the light emitting units, an equivalent intensity of light received on the reference position.

According to an aspect of the invention, the characteristics of the light emitted by the light emitting units can vary such that the spectrum of the light emitted varies for example.

According to an aspect of the invention, the variation in the spectrum of light emitted by the light emitting units makes it possible to highlight certain aspects of the object whose image is to be captured.

According to an embodiment, the triggering of the light emitting units and of the at least one image capturing unit is carried out synchronously.

According to an aspect of the invention, the synchronized triggering of the light emitting units and of the at least one image capturing unit makes it possible to obtain as many light exposures as there are light emitting units.

Thus, it is in particular possible to produce a set of image captures in which each image capture of the set is synchronized with the lighting control of a unit of the set of lighting units.

The various aspects defined above which are not incompatible can be combined.

### BRIEF DESCRIPTION OF THE FIGURES

The invention will be better understood using of the detailed description which is exposed below with reference to the appended drawing in which:

FIG. 1 represents a device for capturing multiple images in accordance with the present invention; and

FIG. 2 represents a flat support for light emitting units according to the present invention.

### DESCRIPTION WITH REFERENCE TO FIGURES

The invention will be better understood using the detailed description which is exposed below with reference to the appended drawing in which:

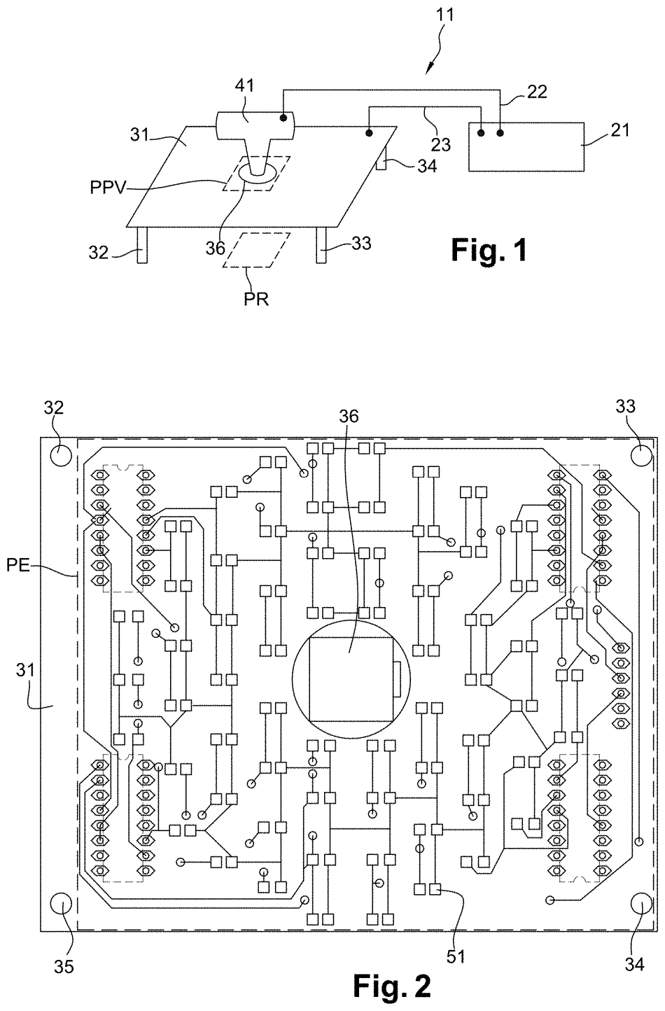

As illustrated in FIG. 1, the device 11 captures multiple images of an object disposed at a reference position PR, each image having a different light exposure.

The device comprises in particular a set of light emitting units 51 disposed on a flat surface 31 as well as at least one image capturing unit 41.

The at least one image capturing unit 41 can be of any kind such as a digital camera or video camera or CMOS/CCD digital sensor or a film camera for example. In the embodiment of the invention illustrated in FIGS. 1 and 2, the image capturing unit 41 is a digital camera.

The light emitting units 51 can be of any kind such as light emitting diodes and/or xenon lamps for example. In the embodiment of the invention illustrated in FIGS. 1 and 2, the light emitting units 51 are light emitting diodes.

As illustrated in FIG. 2, by way of non-limiting example, the set of light emitting units 51 disposed on a flat surface 31 consists of 64 light emitting units.

Advantageously, the set of light emitting units 51 comprises at least one light emitting unit 51.

The flat surface 31 on which the light emitting units 51 are disposed has at least one location 36 so as to allow the insertion of at least one image capturing unit 41.

In order to control the set of light emitting units 51 to obtain at least one light characteristic determined as a function of the distance between a lighting position of the light emitting unit and the reference position PR, as well as to control the triggering of at least one image capturing unit 41 and the light emitting units 51, the device also comprises a monitoring unit 21.

The light intensity of the light emitted by the light emitting units can thus be calculated and controlled as a function of a ratio between the distance between a lighting position of an emitting unit and the reference position.

The light intensity I for an emitting unit can be determined as a function f of the ratio described above and of a maximum light intensity Iₘₐₓ available or determined for an emitting unit:

$$l = f ( \frac{d}{{d}_{max}} , {I}_{max} )$$

The value d corresponds to the distance between the lighting position of the emitting unit and the reference position. The value dₘₐₓ corresponds to the distance between the lighting position of an emitting unit furthest from the reference position among the plurality of lighting position of the assembly of the emitting unit and the reference position.

According to a particular mode of expression of the function f, the light intensity can be determined as follows:

$$l = {( \frac{d}{{d}_{max}} )}^{2} {I}_{max}$$

Of course, an approximate calculation of the function f can be used so as to facilitate the implementation of the determination. According to an embodiment, the distance between the reference position PR and the image capturing unit 41 does not vary. Only the distance between each light emitting unit 51 and the reference position PR changes. In fact, the light emitting units 51 are disposed on the flat surface 31 at different distances from the reference position PR in order to obtain a more homogeneous rendering.

According to an embodiment, the triggering of the at least one image capturing unit 41 and of the light emitting units 51 is performed by the image capturing unit 41.

Such an arrangement makes it possible to obtain permanent lighting, in fact, each light emitting unit 51 is switched on in turn so that there is always a light emitting unit 51 on. Such an arrangement saves time for capturing multiple images.

Hereinafter, a method according to the present invention will be described.

In order to achieve the capture of multiple images each having a different light exposure, several steps are performed.

The first step consists in positioning an object to be photographed on a reference position PR.

The second step consists in capturing a plurality of images from a PPV shooting position using the image capturing unit 41.

During this second step, for each captured image, a lighting is performed, from a lighting position, using the light emitting units 51. The plurality of image capture is associated with a plurality of lighting position comprised in a lighting plane PE.

A lighting is produced from the plurality of lighting position PE using the light emitting units 51 with at least one intensity determined as a function of the distance between the lighting position PE and the reference position PR.

The control unit 21 synchronously triggers the light emitting units 51 and the at least one image capturing unit 41 in order to obtain as many light exposures as there are light emitting units.

Advantageously, the greater the number of light emitting units 51, the greater the number of images captured. This allows to obtain a rendering close to reality.

According to a non-represented embodiment, the multiple image capturing device comprises a single light emitting unit 51 displacing on a plane defined by the flat surface 31 using a displacement unit such as a motorized rail system with two axes for example. Advantageously, a multiple image capturing device comprising a single light emitting unit 51 makes it possible to reduce the weight, size and cost of said device.

According to a non-represented embodiment, the multiple image capture device comprises a subset of light emitting units 51 including several light emitting units 51, said subset is displaced on a plane defined by the flat surface 31 using a displacement unit such as a motorized rail system with two axes for example. Advantageously, a multiple image capturing device comprising a subset of light emitting units 51 makes it possible to reduce the weight, size and cost of said device.

Of course, the invention is not limited to the embodiments represented and described above, but on the contrary, covers all the variants thereof.

1. A device for capturing multiple images of an object disposed at a reference position, each image having a different light exposure, the device comprising:
a set of light emitting units comprising at least one light emitting unit arranged on a flat surface;
at least one image capturing unit;
a monitoring unit; and
the monitoring unit being arranged to control the at least one light emitting unit disposed on the flat surface so as to provide lighting for the at least one light emitting unit with at least one light characteristic determined as a function of a distance between a lighting position of the at least one light emitting unit and the reference position.

2. The device according to claim 1, wherein the at least one image capturing unit is controlled by the monitoring unit.

3. A method for capturing multiple images each having a different light exposure, comprising the following steps:
positioning an object to be photographed at a reference position;
triggering a plurality of image captures from a shooting position;
wherein, during an image capture of the plurality of image captures, lighting is performed from a lighting position, the plurality of image captures being associated with a plurality of lighting positions comprised in a lighting plane; and
wherein the lighting is produced from the plurality of lighting positions with at least one light characteristic determined as a function of a distance between each lighting position of the plurality of lighting positions and a reference position.

4. The method according to claim 3, wherein triggering of different light emitting units at the plurality of lighting positions is performed according to different light characteristics that are dependent upon the distance between each lighting position of the plurality of lighting positions and the reference position.

5. The method according to claim 4, wherein intensity of light emitted by the different light emitting units depends on the distance separating each lighting position of the plurality of lighting positions from the reference position in order to obtain, for each of the different light emitting units, an equivalent received light intensity at the reference position.

6. The method according to claim 5, wherein the triggering of the different light emitting units and at least one image capturing unit is carried out synchronously.

7. The method according to claim 4, wherein the triggering of the different light emitting units and at least one image capturing unit is carried out synchronously.
